(19) United States
(12) Patent Application Publication
(10) Pub. No.: US 2026/0286094 A1
(43) Pub. Date: Sep. 24, 2026

(54) ELECTROMECHANICALLY ROBUST CONDUCTIVE ELASTOMER ENABLED BY A HYBRID-PHASE ALLOY AND METHODS OF PRODUCING THE SAME

(71) Applicant: Carnegie Mellon University, Pittsburgh, PA (US)

(72) Inventors: Carmel Majidi, Pittsburgh, PA (US); Gun-Hee Lee, Pittsburgh, PA (US)

(73) Assignee: Carnegie Mellon University, Pittsburgh, PA (US)

(21) Appl. No.: 19/575,852

(22) Filed: Mar. 23, 2026

Related U.S. Application Data
(60) Provisional application No. 63/775,814, filed on Mar. 21, 2025.

(51) Int. Cl. C08K 3/08; C08J 3/21; C22C 28/00; H01B 1/22

(52) U.S. Cl. CPC C08K 3/08; C08J 3/21; C22C 28/00; H01B 1/22; C08J 2375/04; C08K 2003/0837; C08K 2201/001

(57) ABSTRACT

A composite material includes a network of hybrid-phase metallic particles embedded in a polymer substrate and demonstrates elasticity, stable resistance under strain, and robust mechanical durability. The hybrid-phase particles include a liquid phase and a solid phase bound by common metallic components. Unlike other conductive elastomers, the hybrid-phase metallic particles do no leak from the substrate, especially after repeated strain cycles. A method of fabrication includes mixing metallic particles with a polymer solution, allowing dispersion of the metallic particles within the polymer substrate.

### CROSS-REFERENCE TO RELATED APPLICATIONS

This application claims the benefit under 35 U.S.C. § 119 of U.S. Provisional Application Ser. No. 63/775,814, filed on Mar. 21, 2025, which is incorporated herein by reference.

### STATEMENT REGARDING FEDERALLY SPONSORED RESEARCH

Not applicable.

### BACKGROUND OF THE INVENTION

The present disclosure generally relates to conductive elastomers. More specifically, the disclosure relates to an elastomer embedded with a hybrid-phase alloy that maintains electrical conductivity within the composite when stretched.

Conductive elastomers that combine robust mechanical durability with stable electrical resistivity and conductivity under stretch are critical to the advancement of stretchable electronics, soft robotic sensing skins, and other emerging soft material technologies. However, existing materials based on elastomers embedded with solid conductive filler are fundamentally limited in their ability to simultaneously maintain both electrical stability and material integrity under mechanical loading.

Liquid metals have also been used as filler material due to their ability to deform with the surrounding elastomer and maintain their electrical conductivity when the elastomer is stretched. While liquid metal elastomers show promise, the liquid metal inclusions introduce a risk of leakage, posing a major obstacle to their practical application for on-skin applications. Attempts to resolve this issue, such as blending the liquid metal with silver flakes or other solid metal particles, typically require a high volume of liquid metal and do not fully mitigate the risk of fluid leakage.

Other prior works have focused on micropatterned thin-film metal electrodes with wavy, serpentine, and other spring-like “deterministic” structures have been popular for stretchable electronics. However, they are limited to 2D surfaces rather than bulk 3D structures and involve complex fabrication methods.

Therefore, it would be advantageous to develop a conductive elastomer that has robust mechanical properties, remains conductive when stretched, yet does not leak conductive liquid metals.

### BRIEF SUMMARY

According to embodiments of the present disclosure is a conductive elastomer composite comprising “hybrid-phase” metallic particles (HMP) dispersed within an elastomer substrate. The particles, comprising a mixture of Field's metal and Gallium, synergistically combine the benefits of both solid and liquid fillers. By combining Field's metal (Bi—In—Sn) with a small portion of Gallium (ex. 2.5 vol. %), the composite includes a connected network of rigid metal particles with semi-solid metallic bridges that maintain electrical connectivity under stretch while simultaneously avoiding liquid metal bleed-out or leakage. The composite achieves a unique balance of high conductivity, electromechanical stability, and solid-like material integrity unachievable with other conductive particle compositions. Furthermore, the composite is biocompatible, machine washable, and can be applied to a variety of use cases in wearable electronics and soft robotics sensing.

In contrast to eutectic alloys (i.e. EGaIn or Galinstan) used in conductive elastomers, the composite is not fluidic and not prone to leakage or smearing. Moreover, unlike particles of Field's metal, an alloy of Bi—In—Sn, the hybrid-phase metallic particles have fluid-like malleability at room temperature and freely deform with the surrounding elastomer substrate. In this way, hybrid-phase metallic particles effectively combine the mechanical stability of solid fillers with the stretchability of liquid fillers. This hybrid structure offers robust mechanical durability, allowing electrodes composed of connected hybrid-phase metallic particles embedded within a soft elastomer to withstand extreme deformation while maintaining high electrical conductivity under strain.

### BRIEF DESCRIPTION OF THE SEVERAL VIEWS OF THE DRAWINGS

FIG. 1 shows the composite according to one embodiment.

FIG. 2 depicts the composite fabricated into a stretchable electrode.

FIG. 3 is a schematic showing fabrication steps.

FIG. 4 is a graph showing conductance after stretching for various conductive elastomers.

FIG. 5 is a graph comparing the stress-strain curves of various conductive elastomers, showing the breakage point under strain.

FIG. 6 are graphs comparing stress-strain curves of the composite and a silver flake / LMP elastomer.

FIG. 7 shows the composite compared to a liquid metal particle elastomer after mechanical disruption.

### DETAILED DESCRIPTION

According to embodiments of the disclosure is a conductive composite 100 comprising a polymer substrate 101 and hybrid-phase metallic particles 102. As shown in FIG. 1, the metallic particles 102 are dispersed within the polymer substrate 101 to create an interconnected network of inclusions that form a conductive pathway through the polymer substrate 101. The polymer substrate 101 may comprise an elastomer or other materials capable of elastic deformation, as shown in FIG. 1, right side. The metallic particles 102 comprise a ‘hybrid-phase’ alloy or amalgam of Field's metal and Gallium. Field's metal is known in the art and comprises a mixture of Bi, In, and Sn.

As used in this disclosure, ‘hybrid-phase’ refers to the state of the metallic particles 102 where components of the Field's metal are in the solid phase and the Gallium is in the liquid phase, with interstitial space between the solid and liquid phases occupied by metallic bridges formed from other components in the Field's metal. In this hybrid-phase, the liquid Gallium adheres to the surface of the solid Field's metal, forming a metallic particle 102 that resists leakage like a solid particle but moves fluidly when the polymer substrate 101 is stretched, similar to a liquid.

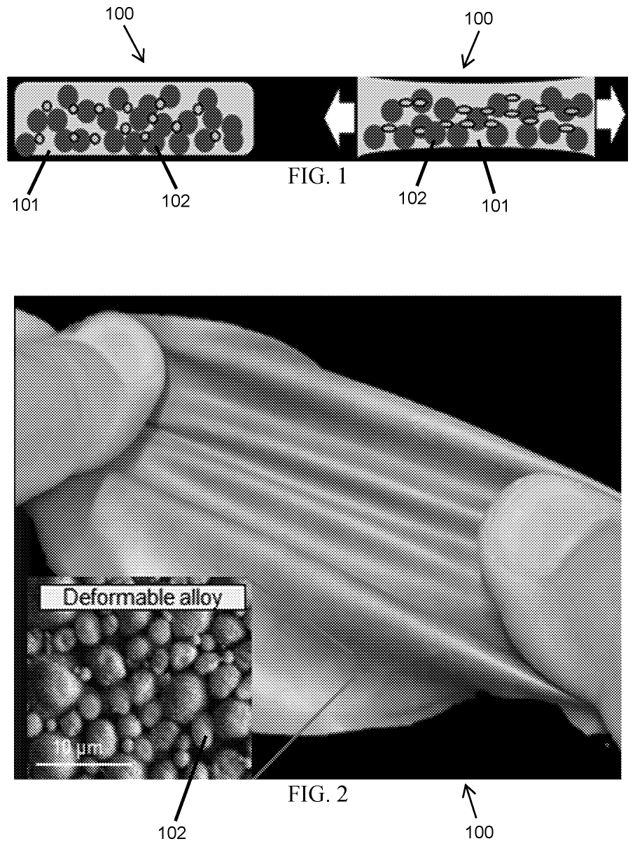

In one example embodiment, the polymer substrate 101 comprises thermoplastic polyurethane, although other polymers can be used, such as silicone rubbers, polyurethane elastomers, thermoplastic urethanes, styrene-isoprene-styrene, and styrene-ethylene-butylene-styrene. The substrate 101 may also include materials that can be stretched to beyond 100% strain and/or have a Young's modulus or elastic modulus or shear modulus of less than 20 MPa. FIG. 2 shows the composite 100 being stretched, with the inset of FIG. 2 showing deformable components of the metallic particles 102.

The metallic particles 102 comprise a blend of Field's metal with a relatively small amount of Gallium. In this example embodiment, the Field's metal is a low-melting point alloy having a melting temperature of 61° C. and has a composition of 32.5% Bi, 51% In, and 16.5% Sn. In typical applications where the composite 100 is used at ambient temperature, the Field's metal or select elements, such as Bi, remain a solid. In addition to Field's metal, the hybrid-phase metallic particles comprise a small portion of pure Gallium or a Gallium alloy (95% Ga and 5% In). For example, the amount of Gallium may be mixed at a 40:1 ratio of Field's metal to pure Gallium. The mixing ratio may vary, only requiring a sufficient amount of Gallium to fill the gaps between Field's metal particles, but not an excess amount that would leak from the substrate 101. In other embodiments, the Gallium can be mixed with the Field's metal as a Gallium-Indium alloy (75.5 wt. % Ga and 24.5 wt. % In).

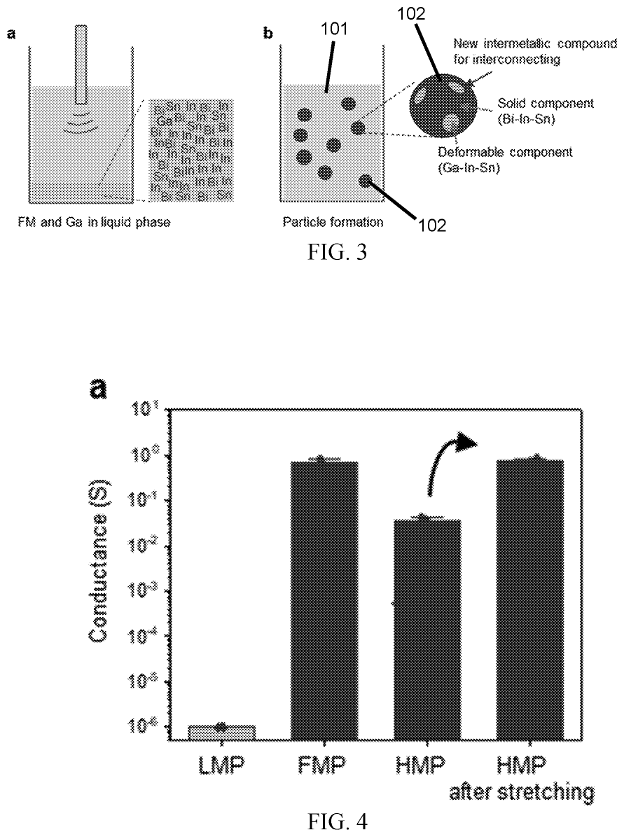

To fabricate the composite 100, the Field's metal and Gallium are heated above their respective melting points, separately added to a polymer solution, which is a polymer dissolved in a solvent, then mixed. The metals and polymer solution can be mixed using sonication, a shear mixer, or an inversion blender. FIG. 3 is a schematic showing the process. In one example, the metallic particles 102 are blended with a thermoplastic polyurethane dissolved in N-methyl-2-pyrrolidone, a high boiling-point solvent that can support high-temperature sonication. Other polymer solvents can be used, such as water, for example. However, low boiling-point solvents may interfere with effective fabrication by inhibiting the dispersion of the Field's metal. For example, when water is used as the solvent instead of N-methyl-2-pyrrolidone, its low boiling point is insufficient for effectively dispersing the Field's metal into microparticles. Consequently, the Field's metal remains undispersed and retains its bulk solid form. After mixing, the solvent is removed, leaving a solid polymer substrate 101 embedded with hybrid-phase metallic particles 102.

While the Field's metal and Gallium can be mixed prior to incorporation with the polymer solution, this process can lead to poor formation of the hybrid-phase as the Gallium is incorporated into the liquid phase Field's metal and remains alloyed when cooled. By mixing the Gallium into the Field's metal within the polymer solution, a bi-phase metallic particle 102 can form.

By way of further detail, the composite 100 may be prepared by dissolving 30 g of thermoplastic polyurethane in 150 ml of N-methyl-2-pyrrolidone. Bulk Field's metal is heated to 80° C. to transition it into a liquid phase, after which 0.4 ml of the molten Field's metal is injected into 10 ml of the thermoplastic polyurethane solution. An additional 0.01 ml of Gallium is added to this mixture in a vial, which is placed on a heat block and subjected to tip sonication at 40% amplitude and 20 kHz frequency for 30 minutes. As noted above, this process ensures the Gallium remains a separate component of the hybrid-phase metallic particles 102. If the Gallium was thoroughly mixed with the Field's metal prior to mixing with the polymer solution, it could be possible for the Gallium to dissolve into the Field's metal, forming a solid phase particle. While this example embodiment describes one fabrication technique, other mixing procedures can be used provided that the metallic particles 102 retain a hybrid-phase.

In an alternative embodiment, a Field's metal-Ga mixture is subjected to high-power sonication at elevated temperatures above the melting points of both Field's metal and Gallium. The elevated temperature allows Field's metal and Ga to melt, facilitating thorough component mixing. As particles formed, the mixture separates into two distinct phases (see FIG. 3): a rigid Bi-based phase (Bi—In—Sn) and a deformable Ga-based phase (Ga—In—Sn, or Galinstan). Shared elements In and Sn enable the formation of intermetallic bonding between the rigid Bi-based phase and the deformable Ga-based phase, creating robust adhesion between the phases within the hybrid-phase metallic particles 102.

More specifically, for effective dispersion of the hybrid-phase metallic particles 102 within the polymer, high-power tip sonication or a similar high energy technique can be used, as the fabrication of hybrid-phase metallic particles 102 necessitates greater energy input compared to low-melting-point metals. Additionally, the process demands heating above the melting point of Field's metal, which is achieved using a heat chamber along with the sonicator, for example. This setup enables uniform dispersion of hybrid-phase metallic particles 102, facilitating the fabrication of the composite 100.

The formation of intermetallic compounds with shared elements promotes both stretchability and mechanical stability, effectively preventing leakage of liquid metal components from the composite 100. In contrast, when Field's metal and Gallium are combined prior to mixing with the polymer, the critical interconnecting phase does not form, resulting in leakage issues within the material. That is, the hybrid-phase metallic particles 102 will not be formed if Field's metal and Gallium are mixed outside of the polymer 101. Instead, the two metals would combine into a single amalgam that would not exhibit hybrid-phase behavior. Additionally, substituting Field's metal with other solid fillers possessing higher surface energy, such as silver flakes, leads to particle aggregation rather than an effective intermetallic formation, even at higher Ga or EGaIn content (volume ratio of 4:1). The resulting composite 100 demonstrates electromechanical properties similar to solid filler-based electrodes, thereby underscoring the impact of appropriate material combinations in achieving the desired performance.

During fabrication of the composite 100, the elevated temperature above the melting points of the metallic components causes the Field's metal and Gallium to transition into a liquid state, enabling thorough mixing within the polymer solution of the metallic elements, Bi, In, Sn, and Ga. During high-power sonication, this liquid Field's metal and Gallium are dispersed into microparticles within the polymer/solvent solution. Upon cooling, the liquid phase undergoes phase separation within each microparticle 102, forming two distinct types: a solid Bi-based alloy phase and a deformable Ga-based alloy phase. While Bi and Ga do not form direct intermetallic compounds with each other, both form intermetallic compounds with In and Sn. The shared presence of In and Sn facilitates the formation of new intermetallic compounds that effectively interconnect the two primary components.

As a result, at room temperature or ambient temperature, the Bi—In—Sn alloy solidifies, creating a mechanically stable framework for the conductive filler. Here, ambient temperature is a temperature below the melting point of Field's metal but above the melting point of Gallium, or more specifically 20-30° C. Simultaneously, the Ga-based intermetallic alloy remains in a liquid-like state, contributing to the material's stretchability and flexibility under mechanical deformation. This unique combination of components enables the hybrid-phase metallic particles 102 to achieve both mechanical durability and stretchability.

When Field's metal and Ga particles are fabricated separately and then physically mixed, the resulting composite 100 exhibits significant leakage of Ga components. In contrast, the composite 100 fabricated as discussed above shows no Ga leakage. Thus, in situ formation of interstitial Galinstan components provide mechanical stability. Without this alloy formation, Ga remains unstable and susceptible to leakage.

After sonication, Bi from Field's metal and Ga, respectively, are dispersed throughout the composite 100. This uniform distribution of solid and deformable components provides the composite with excellent mechanical durability and robustness (see FIG. 2). The solid components serve as a conductive framework, offering mechanical durability. The deformable particles, which fill the interstitial spaces between the solid particles, enhance the composite's stretchability and ensure stable electrical conductivity while also avoiding bleed-out and leakage. While the interconnected network of metallic particles 102 creates a conductive pathway through the composite 100, an electrically insulating composite 100 can be formed in an alternate embodiment by reducing the concentration of metallic particles 102 such that adjacent particles do not contact each other. Stated differently, the metallic particles 102 do not form an interconnected network within the polymer substrate 101.

Under strain, interstitial particles in the composite 100 are elongated. A cross-sectional energy-dispersive X-ray spectroscopy (EDS) analysis reveals that the elongated particles are predominantly composed of Ga. In contrast, Bi particles from the Field's metal retains their spherical shape, demonstrating that the solid phase within the hybrid-phase metallic particles 102 remain undeformed under strain. This confirms the mechanism by which stretchability of the composite is achieved: while the solid Bi-based particles maintain their original shape, the deformable Ga-based interstitial particles elongate under strain, preserving electrical connectivity throughout the network of metallic particles 102 embedded in the substrate 101.

Unlike conventional liquid metal particle (LMP) materials, which typically require mechanical sintering or other post-processing steps to establish electrical contact between adjacent liquid metal droplets, the metallic particles 102 in the composite 100 exhibit immediate electrical conductivity upon composite synthesis. Furthermore, the hybrid-phase metallic particles 102 embedded elastomer composite 100 maintains stable electrical conductivity even under mechanical deformation, achieving the lowest gauge factor among solid-filler-based electrodes, which makes it highly suitable for stretchable electronic applications (see FIG. 4).

In one or more example embodiments, the composite 100 is configured as a conductive film, trace, or electrode (e.g., printed, coated, cast, or otherwise formed) for stretchable circuits and electromechanical systems, including wearable devices and soft robotic components. The solution-based preparation of the composite 100 enables large-scale printing of electrodes and precise patterning, enabling versatile applications. An example of the composite 100 formed as an electrode is shown in FIG. 2, which is capable of conducting electricity to power an LED in both the unstretched and stretched state. In this application, the composite 100 can maintain substantially stable conductance under stretch to support coupled electronic components. By comparison, electrodes formed using silver flakes or low melting point metal fillers may exhibit increased resistance under strain.

FIG. 4 shows the initial electrical conductance values of films composed of various conductive fillers after fabrication on a 4-inch wafer. In the case of LMP-based films, oxidation occurs on the surface of gallium, rendering the film initially non-conductive. Conversely, films based on Field's metal particles exhibit initial conductivity, as surface oxidation is not as prominent as in the LMP system. Notably, the hybrid-phase metallic particle 102 films also exhibits a significant initial conductivity. After application of local strain during peel-off, the resistance of the composite 100 decreases further, primarily due to localized stress concentrations that contribute to the formation of additional internal electrical contacts, resulting in enhanced conductivity reaching a value of 1.2×10⁵ S/m.

A key advantage of hybrid-phase metallic particle-based films is their stable conductance, in contrast to conventional solid conductive fillers. When assessing conductance under strain, the composite 100 exhibits the lowest gauge factor, indicating stable conductance under strain. Additionally, increasing the Ga content in the composite 100 further reduced the gauge factor, demonstrating nearly constant electrical resistance during tensile strains of up to 200%.

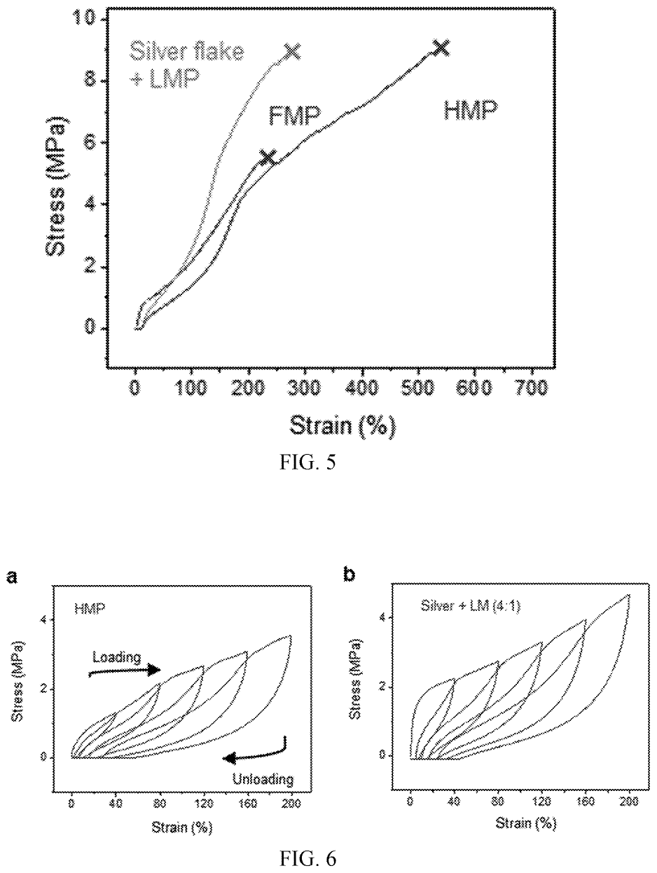

Another benefit of the liquid Ga component in the hybrid-phase metallic particles 102 is a reduction in the composite's Young's modulus, enabling it to stretch under lower mechanical forces compared to other conductive elastomers. The difference in mechanical response compared to other particle-filled elastomers is rooted in the microscale structure of the composite 100. Under applied strain, Ga-based components in the hybrid-phase metallic particles 102 can elongate, allowing effective dissipation of mechanical energy. In contrast, elastomer composites with solid Field's metal particles lack easily deformable metallic inclusions, limiting their ability to dissipate stress, resulting in greater mechanical resistance to deformation and susceptibility to crack fracture. This microparticle-based softening effect significantly enhances the stretchability of the composite 100, setting it apart from both biphasic silver flake/LMP and Field's metal particle composites, as shown in FIG. 5.

By way of further example, FIG. 6 (left side) shows a representative stress-strain curve for an example embodiment of the composite 100 comprising metallic particles 102 embedded in a TPU polymer substrate 101, and FIG. 6 (right side) shows representative stress-strain curves for TPU composites including silver flakes and LMP fillers. In this example, an equivalent volume fraction of conductive filler was utilized to evaluate the mechanical properties of each filler type. The composite 100 with hybrid-phase metallic particles 102 demonstrates a lower mechanical modulus in comparison to silver flakes/LMP-embedded polymer. This results from the uniform dispersion of deformable filler within the composite 100, which facilitates effective dissipation of mechanical stress during tensile deformation. Conversely, the silver flakes and LMP fillers exhibit a tendency to aggregate, limiting the distribution of the deformable LMP phase and consequently diminishing the material's capacity for efficient mechanical stress dissipation.

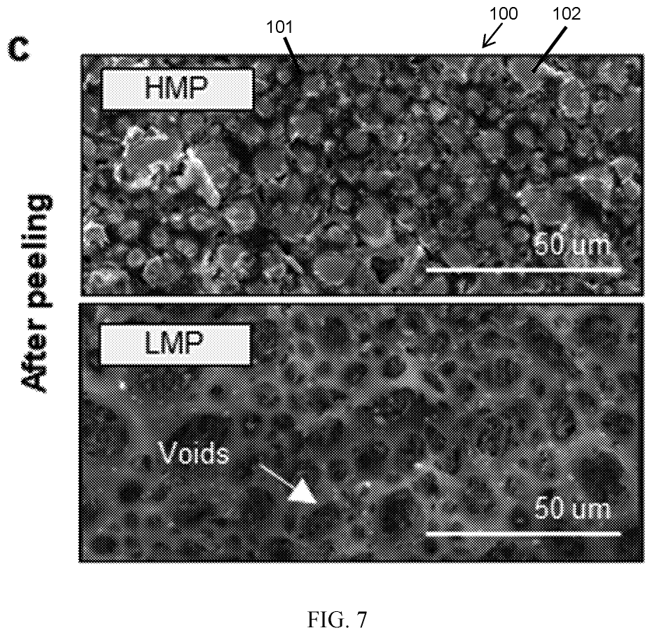

One notable advantage of the composite 100 over EGaIn-based LMP as a dispersion phase for conductive elastomer composites is its ability to support superior mechanical durability. Elastomer composites with LMP inclusions frequently experience leakage and transfer of liquid residue due to the fluidic nature of the inclusions. This limitation is prohibitive for applications that require repeated contact with surfaces, especially with human skin or other biological tissue. Leakages arises because the embedded LM droplets and surrounding elastomer are prone to rupture under mechanical stress. FIG. 7 shows voids in the LMP where liquid metal has leaked from ruptured pockets within the polymer. In contrast, the composite 100 has surfaces predominantly covered by solid components, which prevents leakage even under mechanical stress or tearing of the elastomer.

In some embodiments, electrodes formed from the composite 100 withstand abrasion, impact, tear, and peel while maintaining conductivity. Further, the composite 100 provides high conductivity and stretchability under repeated strain cycles, and, when incorporated into stretchable elastic circuits, can exhibit low modulus and reduced hysteresis between loading and unloading cycles. In some embodiments, printed circuits preserve integrity and conductivity under rubbing, impact, and washing, and can retain substantially stable resistance after repeated wash cycles.

In another example embodiment, the composite 100 is used to form bio-interfaced electrodes configured to couple to soft, deformable biological surfaces while maintaining stable electrical performance. Because skin and tissue deform during use, such electrodes exhibit comparable softness, deformability, and stable conductivity. The composite 100, when integrated into commercially available sports armbands, are able to match the natural deformability of the garment.

In yet another example application of the composite, an electromyography (EMG) armband can be fabricated using electrodes formed from the composite 100 and integrated into a wearable elastic garment such that the electrodes deform with the garment during use. The electrodes are capable of withstanding prolonged wear and repeated washing with substantially stable resistance. For example, testing over short-term wear (e.g., about 1 hour) and extended wear (e.g., about 10 hours) shows minimal change in resistance.

When used in this specification and claims, the terms “comprises” and “comprising” and variations thereof mean that the specified features, steps, or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure. Although certain example embodiments of the invention have been described, the scope of the appended claims is not intended to be limited solely to these embodiments. The claims are to be construed literally, purposively, and/or to encompass equivalents.

What is claimed is:

1. A conductive composite comprising:
an elastomeric polymer substrate; and
a plurality of hybrid-phase metallic particles dispersed in the elastomeric polymer substrate,
wherein the plurality of hybrid-phase metallic particles defines a conductive network through the elastomeric polymer substrate,
wherein individual hybrid-phase metallic particles at ambient temperature comprise a solid phase comprising a bismuth-indium-tin alloy and a deformable phase comprising gallium, the deformable phase being associated with the solid phase such that the conductive composite resists leakage of gallium while maintaining electrical conductivity under strain.

2. The conductive composite of claim 1, wherein the elastomeric polymer substrate comprises thermoplastic polyurethane.

3. The conductive composite of claim 1, wherein the elastomeric polymer substrate is selected from a group consisting of silicone rubber, a polyurethane elastomer, a thermoplastic urethane, styrene-isoprene-styrene, and styrene-ethylene-butylene-styrene.

4. The conductive composite of claim 1, wherein the composite maintains electrical conductivity at greater than 100% tensile strain.

5. The conductive composite of claim 1, wherein the elastomeric polymer substrate 101 has a Young's modulus of less than 20 MPa.

6. The conductive composite of claim 1, wherein the deformable phase comprises a gallium-indium alloy.

7. The conductive composite of claim 1, wherein the deformable phase comprises a gallium-indium-tin alloy.

8. The conductive composite of claim 1, wherein the deformable phase comprises about 2.5 volume % gallium relative to the bismuth-indium-tin alloy.

9. The conductive composite of claim 1, wherein the hybrid-phase metallic particles comprise Field's metal and gallium mixed at a volume ratio of about 40:1.

10. The conductive composite of claim 1, wherein the solid phase and the deformable phase of the individual hybrid-phase metallic particles are joined by intermetallic bonding comprising at least one of indium or tin.

11. The conductive composite of claim 1, wherein the conductive composite is configured as a printed conductive trace, electrode, or film.

12. The conductive composite of claim 1, wherein the conductive network exhibits a substantially constant electrical resistance at tensile strains of up to about 200%.

13. A method of fabricating a conductive composite comprising:
providing a polymer substrate solution comprising a polymer and a solvent;
heating a bismuth-indium-tin alloy to a temperature above a melting point of the bismuth-indium-tin alloy;
separately heating Gallium to a temperature above a melting point of Gallium;
adding each of the bismuth-indium-tin alloy and the Gallium to the polymer substrate solution, forming a mixture;
applying a high-energy mixing process to the mixture to disperse the bismuth-indium-tin alloy and Gallium as metallic microparticles within the polymer substrate solution;
removing the solvent to form a solid polymer substrate; and
cooling to form a plurality of hybrid-phase metallic particles dispersed within the polymer substrate,
wherein individual hybrid-phase metallic particles comprise a solid phase comprising the bismuth-indium-tin alloy and a deformable gallium-containing phase, forming a conductive network of metallic particles dispersed through the polymer substrate.

14. The method of claim 13, wherein applying the high-energy mixing process comprises tip sonication or shear mixing.

15. The method of claim 13, wherein the polymer comprises thermoplastic polyurethane and the solvent comprises N-methyl-2-pyrrolidone.

16. The method of claim 13, wherein heating the bismuth-indium-tin alloy comprises maintaining the temperature at about 80° C.

17. The method of claim 13, wherein cooling causes phase separation within the metallic microparticles to form a Bi-dominant solid portion and a Ga-dominant deformable portion within each hybrid-phase metallic particle.

18. The method of claim 13, further comprising:
forming intermetallic bonding between the solid phase and the deformable phase within the hybrid-phase metallic particles via at least one of indium or tin.

19. The method of claim 13, wherein the gallium is provided as at least one of substantially pure gallium, a gallium-indium alloy, or a gallium-indium-tin alloy.

20. The method of claim 13, further comprising:
depositing the conductive composite as at least one of a conductive film, a conductive trace, or an electrode on an elastic substrate.

21. The method of claim 13, wherein the conductive composite exhibits electrical conductivity immediately upon synthesis without mechanical sintering of liquid metal droplets.
